(19) United States
(12) Patent Application Publication
(10) Pub. No.: US 2023/0308906 A1
(43) Pub. Date: Sep. 28, 2023

(54) Technique for Controlling Network Event Reporting

(71) Applicant: Telefonaktiebolaget LM Ericsson (publ), Stockholm (SE)

(72) Inventors: Attila Báder, Paty (HU); Gergely Dévai, Budapest (HU); Peter Schvarcz-Fekete, Budapest (HU); Virag Weiler, Budapest (HU); József Mala, Cegled (HU)

(21) Appl. No.: 18/020,724

(22) PCT Filed: Sep. 30, 2020
(86) PCT No.: PCT/EP2020/077373

§ 371 Date: Feb. 10, 2023

(51) Int. Cl. H04W 24/02; H04W 24/10

(52) U.S. Cl. CPC H04W 24/02; H04W 24/10

(57) ABSTRACT

According to the present disclosure, a technique for controlling reporting of network events by one or more network functions, NF, of a wireless communication network is provided. A method implementation of this technique comprises receiving, from at least one network analytics component, a network analytics request indicative of at least one event reporting requirement of the at least one network analytics component, and receiving, from at least one IMF, one or multiple NF reports indicative of at least one of an event reporting capability, a load and a capacity of the at least one NF. The method further comprises generating an event reporting request based on the at least one event reporting requirement and at least one of the event reporting capability, the load, and the capacity of the at least one NF, and sending the event reporting request to the at least one NF so as to control event reporting by that at least one NF.

### TECHNICAL FIELD

The present disclosure generally relates to wireless communication networks. In particular, a technique for controlling reporting of network events by one or more network functions, NF, of a wireless communication network is disclosed. The technique may be implemented in the form of a method, a computer program product, an apparatus, and a system.

### BACKGROUND

Network management is an important feature of modern wireless communication networks. Network management decisions require a continuous collection and analysis of a plethora of network events occurring locally within the managed network and reported by the network to a network management domain. Such network events are typically reported on a subscriber level to achieve a sufficiently high resolution for network analysis.

Traditional event collection is based on passive probing of, or pre-configured event reporting by, different network functions within possibly different domains of a wireless communication network. While the volume of reported network events is already significant in wireless communication networks of the current 4th Generation (4G), the event reporting volume is expected to drastically increase with the deployment of 5th Generation (5G) networks (also called New Radio, NR, networks). This increase is partly due to much higher numbers of terminal devices of various kinds, including Internet of Things (IoT) devices, and partly the result of new service types that will become available in 5G networks.

As an example, it is expected that event collection by user plane probing in a 5G network will per core network site easily result in several terabit of user plane traffic that needs to be processed and evaluated in real time. A similar situation will arise in the radio access network domain as a result of the increasing numbers of devices and cells. Evidently, significant server capacities, and also a lot of electric power, will be consumed in this regard.

Attempts have been made to reduce the reported volume of network events. For example, it has been suggested to apply random event sampling techniques to reduce the amount of data that needs to be analyzed for network management purposes. However, such random sampling of network events has been found to reduce the efficiency of network anomaly detection as it cannot be ensured that, for example, problematic communication sessions are not “filtered out” in view of the applied randomness.

### SUMMARY

There is a need for efficiently controlling reporting of network events in a wireless communication system.

According to a first aspect, a method of controlling reporting of network events by one or more network functions, NF, of a wireless communication network is provided. The method comprises receiving, from at least one network analytics component, a net-work analytics request indicative of at least one event reporting requirement of the at least one network analytics component, and receiving, from at least one NF, one or multiple NF reports indicative of at least one of an event reporting capability, a load and a capacity of the at least one NF. The method further comprises generating an event reporting request based on the at least one event reporting requirement and at least one of the event reporting capability, the load, and the capacity of the at least one NF, and sending the event reporting request to the at least one NF so as to control event reporting by that at least one NF.

As understood herein, the term “multiple” generally denotes a number of two or more.

A particular NF and/or a network particular analytics component may be a software entity (e.g., implemented using cloud computing resources), a stand-alone hardware entity (e.g., in the form a network node), or a combination thereof. A particular NF may belong to a cellular wireless communication network, for example of the 4^{th} or 5^{th} Generation. A particular NF may belong to a radio access network (RAN) domain or a core network (CN) domain of the cellular wireless communication network. A particular network analytics component may belong to a network management (NM) domain of the wireless communication network.

The method may comprise receiving multiple network analytics requests that are collectively indicative of multiple event reporting requirements. The method may further comprise merging the multiple event reporting requirements into an overall event reporting requirement for the at least one NF. In this case, the event reporting request sent to the at least one NF can be based on the overall event reporting requirement. As an example, the event reporting request may include the overall event reporting requirement (e.g., as a numerical or non-numerical parameter) or a parameter derived therefrom.

The network analytics requests may be received from one and the same network analytics components or from multiple different analytics components. As such, at least two of the multiple event reporting requirements may be received from different network analytics components (potentially operated by different users within the NM domain of one network operator or by different network operators).

At least two of the multiple event reporting requirements may comprise a numerical value. In such a case, merging the multiple event reporting requirements may comprises deriving, from the (possibly different) numerical values comprised in the at least two of the multiple event reporting requirements, an overall numerical value to be comprised by the overall reporting requirement. The overall numerical value may, for example, be the least or greatest common multiple of the numerical values, a minimum or maximum of the numerical values, and so on.

Multiple NF reports may be received from multiple NFs. In such a case, the event reporting request for a particular one of the multiple NFs can be individualized based on at least one of the event reporting capability, the load and the capacity of that particular NF. As an example, in case the load or capacity relates to one or more of general processing, monitoring or storage resources of a particular NF, the event reporting request may be generated such that a currently high processing load or a currently low monitoring capacity of that particular NF is not (or not significantly) worsened. This approach may result in the event reporting requirement not (or not fully) being satisfied by that particular NF.

The event reporting request may be indicative of at least one of an event sampling rate to be applied by the at least one NF, an event filter setting to be applied by the at least one NF, and one or more key performance indicators, KPIs, for which event reporting is to be performed by the at least one NF.

If the event reporting requirement is indicative of at least one KPI and an associated precision requirement, the method may comprise calculating the event sampling rate based on the precision requirement, wherein the event reporting request is indicative of at least the calculated event sampling rate and the at least one KPI. If the event reporting request is indicative of at least the event sampling rate, the method may comprise sending, to the at least one network analytics component, a message indicative of the event sampling rate or a parameter derived therefrom.

The event filter setting may be indicative of one or more of a set of (i) one or more network subscribers to be covered by NF event reporting, (ii) a wireless device class or type to be covered by NF event reporting, and (iii) a geographic area to be covered by NF event reporting. The network subscribers to be covered by NF event reporting on a subscriber level may be identified in various ways, for example by a set of one or more subscription permanent identifiers (SUPIs), a set of one or more international mobile subscriber identities (IMSIs), a set of one or more cell identifiers, a set of one or more radio session identifiers, and so on.

The NF report from the at least one NF may be indicative of an NF event reporting capability in terms of an event filter supported by the at least one NF. In such a case, generating the event reporting request for the at least one NF may comprise processing the event reporting requirement to result in an event filter setting compatible with the event filter supported by the at least one NF. The event filters may relate to identifiers used in the network. As an example, in case a given NF only supports radio session identifiers for event filtering on a subscriber level, and in case the event reporting requirement is indicative of a cell identifier or a set of SUPIs or IMSIs, the latter may be converted to radio session identifiers (as event filter settings) when generating the event reporting requirement that is to be transmitted to the NF.

If multiple NF reports are received from multiple NFs, the multiple reports may be indicative of different event filters supported by different NFs. In such scenario, generating the event reporting requests for the NFs may comprises processing the network reporting requirements to result in coherent event filter settings compatible with the different events filters supported by the different NFs. In the above example, a first NF only supporting radio session identifiers may thus receive a set of radio session identifiers, whereas a second NF only supporting SUPIs may receive a set of SUPIs that is coherent with the set of radio session identifiers (e.g., in terms of the set of subscribers to be covered).

The processing of the network reporting requirements may, for example, target at controlling event reporting by the multiple NFs such that the multiple NFs are configured to report events pertaining to a particular communication session (e.g., an end-to-end session between different user terminals or a user terminal and an application server) despite their different event filters. The correspondingly reported events may then easily be correlated in the NW domain (e.g., by the analytics components) by applying a mapping reflecting the different event filters (e.g., a mapping between different identifier types associated with the same communication session). Such a mapping may previously have been communicated to the event reporting control component to facilitate the processing the network reporting requirements to result the coherent event filter settings.

When multiple NF reports are received from a particular NF, a first NF report of the multiple NF reports may be indicative of the event reporting capability of that particular NF. Moreover, a second NF report of the multiple NF reports may be indicative of at least one of the load and the capacity of that particular NF. For example, when sending an NF capability request to the particular NF, the first NF report may be received responsive to the NF capability request. Sending the NF capability request may be triggered by receipt of the network analytics request. As a further example, the second NF report may be received repeatedly (e.g., periodically) after the event reporting request has been sent to the particular NF. The second NF report may further be indicative of current event reporting settings (e.g., a current event filter setting or a current sampling rate) of the particular NF.

The method may in some scenarios comprise receiving, from the at least one network analytics component, analytics information derived from the NF event reporting and generating a further event reporting request based on at least the analytics information. The method may further comprise sending the further event reporting request to the at least one NF so as to modify event reporting by that at least one NF. The analytics information may be indicative of at least one of (i) a network anomaly (e.g., a severely degraded service quality for a dedicated subscriber or set of subscribers), (ii) a number of events reported by a particular NF, optionally for a particular KPI, and (iii) a mapping of identifiers used in different network domains (e.g., SUPI to radio session identifier, or vice versa).

The further event reporting request may be generated also based on at least one of the event reporting capability, the load and the capacity of the at least one NF. Additionally, or as an alternative, the further event reporting request may control a modification of at least one of a currently applied event sampling rate, a currently monitored KPI set, a currently reporting set of NFs, and a currently applied event filter setting.

The one or more NFs may be implemented using cloud computing resources. In such a case, an amount of cloud computing resources allocated to a particular NF may be dependent on the event reporting request sent to that particular NF. If, for example, the requested event reporting results in an increased load or a reduced capacity of the particular NF, more cloud computing resources may be allocated by a cloud orchestrator to that particular NF.

The method can comprise determining if the network analytics request from the at least one network analytics component can be fulfilled in view of at least one of the event reporting capability, the load and the capacity of the at least one NF. The method may further comprise sending, to the at least network analytics component, a network analytics response message indicative of a result of the determination (e.g., indicative of the fact that the network analytics request cannot, or not fully, be fulfilled).

In some implementations, the method is performed by an event reporting control component having a first interface towards the at least one network analytics component and a second interface towards the at least one NF. The event reporting control component can be co-located with the at least one network analytics component in an NM domain. Optionally, the NM domain further comprises an event collection component having a third interface towards the at least one network analytics component and a fourth interface towards the at least one NF for receiving event reports from the at least one NF.

Multiple NFs may be provided in different network domains of the wireless communication network. The different network domains may comprise at least an RAN domain and a CN domain. In such a case, multiple NF reports may be received from, and multiple event reporting requests may be sent to, NFs provided in the different network domains.

Also provided is a computer program product comprising program code portions for performing the steps of any of the methods presented herein when the computer program product is executed by a processor or set of processors. The computer program product may be stored on a computer-readable recording medium.

Further provided is an apparatus for controlling reporting of network events by one or more NFs of a wireless communication network. The apparatus is configured to receive, from at least one network analytics component, a network analytics request indicative of at least one event reporting requirement of the at least one network analytics component and, to receive, from at least one NF, one or multiple NF reports indicative of at least one of an event reporting capability, a load and a capacity of the at least one NF. The apparatus is also configured to generate an event reporting request based on the at least one event reporting requirement and at least one of the event reporting capability, the load and the capacity of the at least one NF, and to send the event reporting request to the at least one NF so as to control event reporting by that at least one NF.

The apparatus may be configured to perform any of the method steps presented herein.

Still further, another apparatus for controlling reporting of network events by one or more NFs of a wireless communication network is presented. The other apparatus comprises a processor and a memory coupled to the processor, the memory comprising instructions executable by the processor whereby the apparatus is operative to perform a method presented herein.

Also provided is an NM system comprising the apparatus presented herein. The NM system further comprises the at least one network analytics component.

### BRIEF DESCRIPTION OF THE DRAWINGS

Further aspects, details and advantages of the present disclosure will become apparent from the detailed description of exemplary embodiments below and from the drawings, wherein:

FIG. 1 is a diagram illustrating a network system embodiment of the present disclosure;

FIG. 2 is a block diagrams illustrating an embodiment of an event reporting controller apparatus in accordance with the present disclosure;

FIG. 3 is a flow diagram of a method embodiment of the present disclosure;

FIG. 4 is a signalling diagram illustrating a more detailed method embodiment of the present disclosure;

FIGS. 5-8 are flow diagrams illustrating further method embodiments of the present disclosure;

FIG. 9 is a schematic illustration of the available and required amount of data in different cells for analytics purposes (e.g., anomaly detection); and

FIG. 10 is a schematic diagram summarizing the decision basis of the event reporting control presented herein.

### DETAILED DESCRIPTION

In the following description, for purposes of explanation and not limitation, specific details are set forth in order to provide a thorough understanding of the present disclosure. It will be apparent to one skilled in the art that the present disclosure may be practiced in other embodiments that depart from these specific details.

While, for example, some embodiments of the following description focus on an exemplary core network configuration in accordance with specific 4G and 5G specifications, the present disclosure is not limited in this regard. The present disclosure could also be implemented in other cellular or non-cellular wireless communication networks.

Those skilled in the art will further appreciate that the steps, services and functions explained herein may be implemented using individual hardware circuits, using software functioning in conjunction with a programmed microprocessor or general purpose computer, using one or more application specific integrated circuits (ASICs) and/or using one or more digital signal processors (DSP). It will also be appreciated that when the present disclosure is described in terms of a method, it may also be embodied in one or more processors and one or more memories coupled to the one or more processors, wherein the one or more memories store one or more computer programs that perform the steps, services and functions disclosed herein when executed by one or more processors.

In the following description of exemplary embodiments, the same reference numerals denote the same or similar components.

The embodiments that follow generally relate to reporting of network events, to controlling the event reporting and to analyzing the reported events. As understood herein, network events are to be construed broadly. Network events generally characterize what is happening in a communication network, such as session initiation or termination, the status of an ongoing session, transmission of a certain amount of data and so on. So called key performance indicators, or KPIs, (usually numeric) can be reported as events as such or as attributes of one or more events, such as session initiation time, ratio of unsuccessful session initiations, the amount of transmitted bytes over a given amount of time and so on. An event can be reported when it is locally detected by an NF or in response to probing. The events can be standardized (e.g., 4G or 5G) signalling events or vendor-specific events (of, e.g., a network node acting as NF). Event probing may be performed to capture the events at a network interface or to capture user plane traffic, sample it and generate user plane traffic metrics that are to be reported as one or more events. KPIs can be calculated from or attributed to one or multiple events.

As an example, a handover failure can be reported in an event. Exemplary KPIs calculated from this or these events either locally in the communication network or centrally in an NM domain are a number of handover failures or a ratio of the handover failures and the total handovers in a time period. As another example, a user plane probe may report a throughput event every 5 s in a dedicated event report. An average throughput KPI can be calculated locally or centrally as the average of these throughputs for 1 min, and a maximum throughput KPI can be calculated locally or centrally as the maximum of the reported throughputs in 1 min.

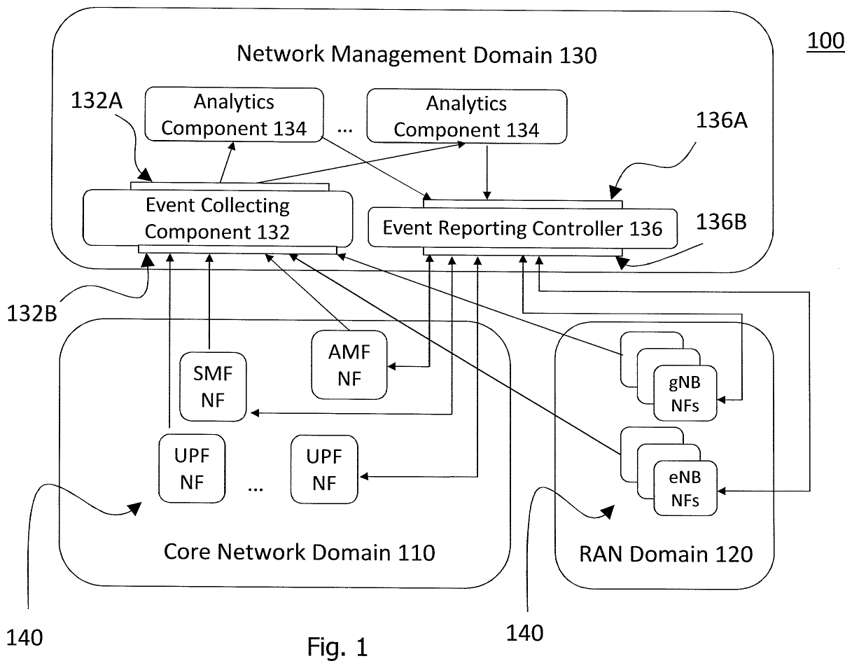

FIG. 1 illustrates an embodiment of a system 100 in which the present disclosure can be implemented. The system 100 comprises a wireless communication network with a RAN domain 110 and a CN domain 120, as generally known in the art. The system 100 further comprises an NM domain 130 configured to communicate with both the RAN domain 110 and the CN domain 120.

The CN domain 110 and the RAN domain 120 each comprises a large number of NFs 140. A particular NF 140 may be a software entity (e.g., implemented using cloud computing resources), a stand-alone hardware entity (e.g., in the form a network node), or a combination thereof. When using cloud computing resources, an amount of cloud computing resources allocated to a particular NF 140 may be dependent on the event reporting load on that particular NF. If, for example, the requested event reporting load results in an increased load or a reduced capacity of the particular NF 140, more cloud computing resources may be allocated by a cloud orchestrator to that particular NF 140. Each NF 140 comprises a bi-directional communication link to the NM domain 130 for receiving event reporting requests from the NM domain 130 and sending event reports to the NM domain 130.

The exemplary NFs 140 of FIG. 1 belong to a 5G wireless communication network as currently standardized by the 3^{rd} Generation Partnership Project (3GPP). In more detail, the CN domain 110 comprises, inter alia, multiple user plane functions (UPFs), a session management function (SMF) and an access and mobility management function (AMF). The RAN domain 120 comprises multiple base stations in the form of so-called eNodeBs (eNBs) and gNodeBs (gNBs). In some variants, the NFs 140 as presented herein may conform to the definitions of “network functions” as standardized by 3GPP in its 5G specifications, but in other variants (e.g., in 4G implementations) this may not be the case.

As illustrated in FIG. 1, the NM domain 130 comprises an event collecting component 132, a plurality of network analytics components 134 and an event reporting control component (event reporting controller hereinafter) 136. The latter is added as an extra event reporting control layer between the analytics components 134 on the one hand and the CN and RAN domains 110, 120 on the other hand.

The analytics components 134 are each configured to send network analytics requests to the event reporting controller 136 that receives these requests via a dedicated interface 136A. Moreover, the event reporting controller 136 comprises a further dedicated interface 136B towards the NFs 140 to receive NF reports from the NFs and to send event reporting requests towards the NFs. The interfaces 136A, 136B can each be configured as a software interface, a hardware interface or a combination thereof. As will be explained in greater detail below, the event reporting controller 136 may be configured to generate the event reporting requests based on information contained in the NF reports as received from the NFs 140 and based on information contained in the network analytics requests as received from the analytics components 134.

The analytics components 134 are not only configured to generate the network analytics requests for the event reporting controller 136, but also to analyse the events collected from the NFs 140 by the event collecting component 132. To this end, the event collecting component 132 has a dedicated interface 132A that provides the analytics components 134 with access to an event collection database hosted by the event collecting component 132. The event collection component 132 has a further dedicated interface 132B towards the NFs 140 to receive event reports from the NFs 140. The event collection component 132 is configured to store the events reported by the NFs 140 in its event collection database. The interfaces 136A, 136B can each be configured as a software interface, a hardware interface or a combination thereof.

The analytics components 134 may be configured as customer experience management (CEM) systems or subscriber analytics systems (such as Ericsson Experts Analytics, EEA, systems). The analytics systems 134 may be comprised by one or more of network operation centres (NOCs), service operation centres (SOC) and network optimization engineering (NOE) systems. In some implementations, the analytics systems 134 are configured to monitor and analyse service quality and network quality on a subscriber level. The analytics systems 134 may be software entities (e.g., implemented using cloud computing resources), (e.g., stand-alone) hardware entities, or combinations thereof.

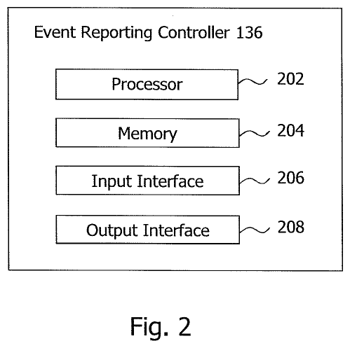

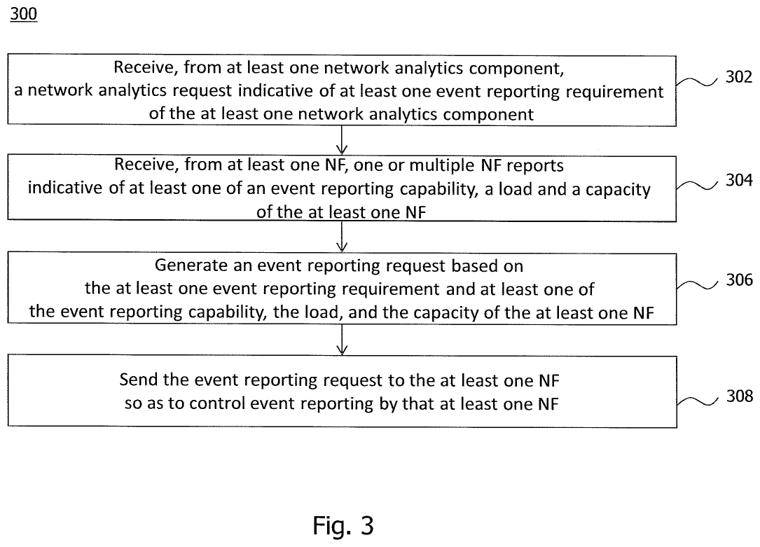

In the following, an apparatus embodiment of the event reporting controller 136 of FIG. 1 will be described with reference to FIG. 2, and general operation of the event reporting controller 136 will be described with reference to a method embodiment illustrated in flow diagram 300 of FIG. 3.

In the apparatus embodiment illustrated in FIG. 2, the event reporting controller 136 comprises a processor 202 and a memory 204 coupled to the processor 202. The memory 204 stores program code (e.g., in the form of a set of instructions) that controls operation of the processor 202 so that the event reporting controller 136 is operative to perform any of the method aspects presented herein. As understood herein, a processor, such as processor 202, may be implemented using any processing circuitry and is not limited to, for example, a single processing core but may also have a distributed topology (e.g., using cloud computing resources).

The event reporting controller 136 further comprises an input interface 206 and an output interface 208. The two interfaces 206, 208 are configured for communication with the analytics components 134 on the one hand and the NFs 140 on the other hand. The interfaces 206, 208 may be configured to implement the interfaces 136A, 136B described above with reference to FIG. 1.

Now referring to the flow diagram 300 of FIG. 3, operation of the event reporting controller 136 comprises a step 302 of receiving, from at least one of the analytics components 134, a network analytics request indicative of at least one event reporting requirement of the at least one network analytics component 134. The network analytics request will be received via the input interface 206 (when implementing the interface 136A of FIG. 1).

Operation of the event reporting controller 136 further comprises a step 304 of receiving, from at least one of the NFs 140, one or multiple NF reports indicative of at least one of an event reporting capability, a load and a capacity of the at least one NF 140. The one or more NF reports will be received via the input interface 206 (when implementing the interface 136B of FIG. 1).

Steps 302 and 304 may be performed in any order, and also concurrently. In some scenarios, receipt of the network analytics request by the event reporting controller 136 triggers sending a dedicated request by the event reporting controller 136 towards one or more of the NFs 140, which in turn triggers the one or more NFs 140 so send their NF report(s) to the event reporting controller 136.

The method further comprises, in step 306, generating, by the processor 202 of the event reporting controller 136, an event reporting request based on the at least one event reporting requirement and at least one of the event reporting capability, the load, and the capacity of the at least one NF. Still further, the method comprises, in step 308, sending the event reporting request to the at least one NF 140 so as to control event reporting by that at least one NF 140 towards the NM domain 130 (i.e., towards the event collecting component 132). The event reporting request will be sent by the event reporting controller 136 via the output interface 208 (when implementing interface 136B of FIG. 1).

The event reporting request will be indicative of one more of an event sampling rate and an event filter setting to be applied by the NF 140. Additionally, or as an alternative, the event reporting request may indicate one or more KPIs for which event reporting is to be performed by the NF 140. In some cases, the event filter setting may define a set of subscribers to be monitored for reporting purposes. In such a case, the event filter setting may comprise a white list of the subscriber to be monitored or a black list of subscribers not to be monitored. The corresponding list may be defined using SUPIs, IMSIs or any other identifier type. The list may, for example, include or exclude certain subscribers based on consent or subscription type.

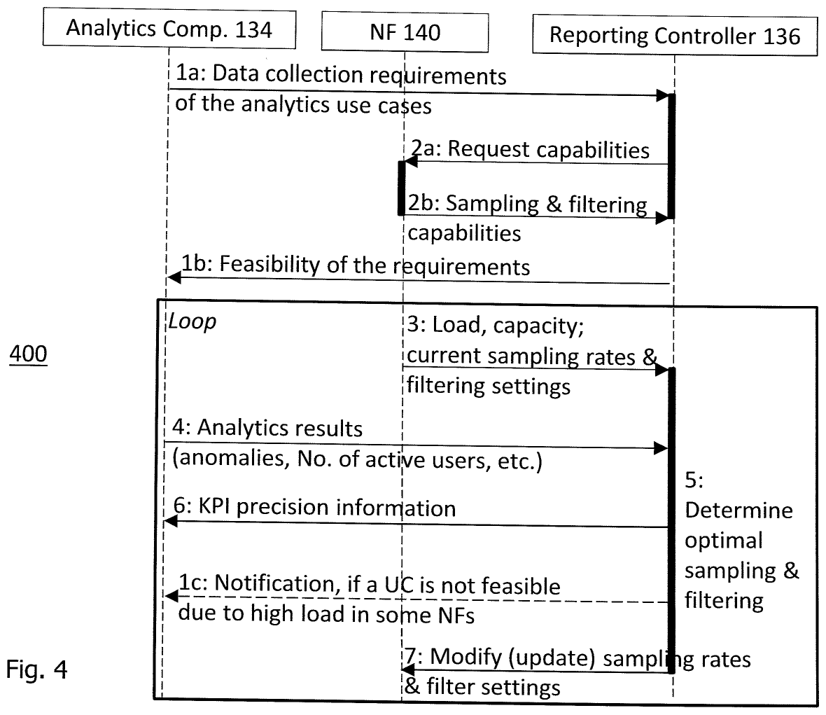

The method embodiment of FIG. 3 and co-operative operation of the event reporting controller 136, of one of the NFs 140 and of one of the network analytics components 134 will now be described in greater detail with reference to the signalling diagram 400 of FIG. 4.

In step 1a, one of the network analytics components 134 of FIG. 1 sends a network analytics request to the event reporting controller 136. The network analytics request indicative of at least one event reporting requirement of the at least one network analytics component 134. The event reporting requirement defines one or more data collection requirements of one or more analytics use cases. Such use cases (UCs) may be pre-defined, or they may be defined on a case-by-case basis by the network analytics component 134. In case of a predefined UC, the network analytics component 134 may simply request activation and, optionally, configuration of the predefined UC from the event reporting controller 136. As an example, the network analytics component 134 may send an identifier of the UC and a set of one more UC configuration parameters in step 1a.

Receipt of the network analytics request by the event reporting controller 136 (see step 302 of FIG. 2) triggers the event reporting controller 136 to send an NF capability request to one or more of the NFs 140 in step 2a of FIG. 4. In some variants, the particular NFs 140 to be contacted in this regard may be defined in the network analytics request (optionally in an abstract manner, e.g., by indication of an NF type). To this end, the event reporting controller 136 may maintain a detailed NF map for one or both of the CN domain 130 and the RAN domain 120.

In step 2b, each of the one or more NFs 140 returns a dedicate NF report indicative of the NF's 140 event reporting capability to the event reporting controller 136 (see step 304 in FIG. 3). In the present embodiment, the event reporting capability reported in the NF report is indicative of event sampling and event filtering capabilities of a particular NF 140 (e.g., in terms of one or more of supported event types, supported event sampling rates and supported event filters).

Based on the information received in the NF report(s), the event reporting controller 136 determines if the NF(s) 140 can fulfil, or support, the event reporting requirement(s) as signalled by the at least one network analytics component 134 in step 1a. The event reporting controller 136 then, in step 1b, returns a network analytics response message to the network analytics component 134. This message indicates whether or not fulfilment of the event reporting requirement(s) is feasible. As an example, support of certain UCs may be infeasible due to the required event type(s), event sampling rate(s) or event filter(s) not being supported by the required NF(s) 140.

The NF 140 may be pre-configured, or may be configured by the event reporting controller 136 in message 2a or in a dedicated configuration message, to regularly (e.g., periodically) send further NF reports indicative of one or both of the current NF processing load and the current NF event monitoring capacity to the event reporting controller 136 (see step 3 in FIG. 4). In some cases, the NF reports may additionally include information on the current event sampling rates and/or current event filter settings. Those parameters may have been generated and configured by the event reporting controller 136 earlier, for example in step 2a or between step 1b and step 3 (as explained above with reference to steps 306 and 308 in FIG. 3). As illustrated in FIG. 4, the further NF reports may by received in a continuous loop during a reporting period.

Occasionally, the network analytics component 134 may send analytics information to the event reporting controller 136, see step 4 in FIG. 4. This analytics information may, for example, have been generated by the analytics component 134 based on an analysis of the events gathered by the event collecting component 132 or otherwise. The analytics information may be indicative of a network anomaly detected by the analytics component(s) 134, a number of events reported by a particular NF 140 (e.g., for a certain KPI), location(s) of active subscriber(s), a mapping between identifiers used in different the network domains 110, 120, and so on. The analytics information may be gathered or derived from basic event metrics, network incidents, and triggers from other analytics information, for example using rule injection, subscriptions to specific data feeds, and so on.

While the loop illustrated in FIG. 4 is executed, the event reporting controller 136 continuously determines, based on the information received in one or more of steps 1a, 2b, 3 and 4, whether there is a need to modify event reporting by one or more of the NFs 140 (see step 5). If so, the event reporting controller 136 in step 7 controls one or more of the NFs 140 to set and/or update event reporting settings. This control may be NF-specific in case NF loads and capacities are taken into account.

An initial, or first, communication of the event reporting request (e.g., with, optionally default, settings of event filters and sampling rates) to the NFs 140 may have happened in step 7 upon a first iteration of the loop. During this first iteration, step 3 may report no sampling and no filters being applied (i.e., there is no data collection and associated event reporting); steps 4 and 6 may be void; and step 5 may determine default settings taking into account the requirements from step 1a and the load/capacity information from step 3. In such a scenario, step 7 may be the first communication of the settings to the NFs 140.

A later modification of reporting parameters in step 7 may include one or more of currently applied sampling rates, currently applied event filter settings, currently reporting set of NFs 140 (i.e., stopping or resuming event reporting by a particular NF 140), and currently monitored KPIs.

The event reporting controller 136 may further inform the analytics component 134 of the precision that currently is feasible for a given KPI subject to event reporting, see step 6. This KPI precision information may be derived by the event reporting controller 136 from the currently applied (or requested) event sampling rate of a given NF 140 or across a given set of NFs 140. In some variants, the analytics component 134 may have indicated, for example in step 1a, a precision requirement for a KPI (e.g., as part of a UC requirement) for which event reporting is to be performed. In such a case, the event reporting controller 136 may have calculated the required event sampling rate based on the precision requirement (with a higher precision requirement leading to a higher sampling rate). In case the event reporting controller 136 determines (e.g., from the information received in step 3 or in case of a lowering of the sampling rate in step 7) that the precision requirement, or any other UC requirement, can no longer be fulfilled, it will notify the analytics component 134 thereof in step 1c. The reason for such a notification may be that one or more of the NFs 140 have entered a state of high processing load with an associated low event monitoring capacity, that lead to an event sampling rate reduction in step 7.

Instead of, or in addition to, increasing the event sampling rate, the event filter settings may be modified to increase the event reporting precision (e.g., by extending a white list of subscribers to be monitored). Such increase(s) may be performed in case network anomalies are signalled by the analytics component 134 in step 4 to support root cause analysis in the NW domain 130. The increase(s) may specifically be performed for certain network sites (e.g., geographic areas such as cells), subscriber segments or device types affected by the network anomaly. Evidently, different sampling and filter settings may be chosen for different network sites. In some cases, the event reporting controller 136 may request the NFs 140 to perform random sampling (e.g., of randomly selected communication sessions). Optionally, the subscribers are divided into random segments (e.g., hash bins across SUPIs or IMSIs) for event reporting.

The loop illustrated in FIG. 4 permits a dynamic event reporting control. The loop may end after a pre-defined period of time. Alternatively, the analytics component 134 may inform that event reporting controller 136 that event reporting is to be stopped.

In the following, various UC and a merging of UCs will be described with reference to the exemplary scenarios of FIGS. 3 and 4. Assume that a first UC (UC1) of a first analytics component (AS1) 134 requires at least 1.000 session records (or all, if total is less) from each NF 140 of a particular NF type to be reported (as indicated in step 1a). Assume further that three distinct NF load profiles are defined within each of the CN domain 110 and the RAN domain 120 (constant heavy-load, constant low-load, normal daily profile), and that the NF type of interest only supports IMSI filtering and sampling.

Based on the prevailing load information received in step 2b or step 3, the NFs 140 will get different sampling requests from the event reporting controller 136: heavily-loaded: 1% sampling, low-loaded: 100% sampling, and normal profile: sampling based on current load. As explained above, the load (step 3) and reported event record count (step 4) will be constantly monitored by the event reporting controller 136 and will be used to correct the filter configuration and an associated reporting (step 1c) in case UC1 requirements are not met. With current solutions, this correction needs to be done manually, resulting in high operational costs of the NM domain 130.

In case the event reporting controller 136 receives multiple network analytics requests in step 1a (from one multiple analytics components 134), the multiple event reporting requirements received therewith may be merged to an overall event reporting requirement, possibly per NF 140, that is then communicated to the one or more NFs 140.

Using the previous example, AS1 would like to add a new use case (UC2) similar to UC1, but which requires at least 10% sampling on all NFs 140. The event reporting controller 136 will merge the requirements of UC1 and UC2 as follows. On low-loaded NFs 140, it will keep the 100% sampling rate, on heavily-loaded NFs 140, it will raise the rate from 1% to 10%, and on standard daily profile nodes, it will set the rate to 10%, if it is more than 1000 record, or a percentage higher than 10, to satisfy both UCs.

Using the previous examples, a second analytics component 134 (AS2) may have been added to the NM domain 130, which adds a third use-case (UC3) which requires 5% of subscribers to monitored. The event reporting controller 136 will attempt to merge the three UCs, and it will determine that requirements of UC3 have been already met by UC2, so adding this new UC3 will not raise the load on the NFs 140. With current solutions, this step needs to be done manually, or needs to be automated in an integration step during AS deployment, which is quite inflexible.

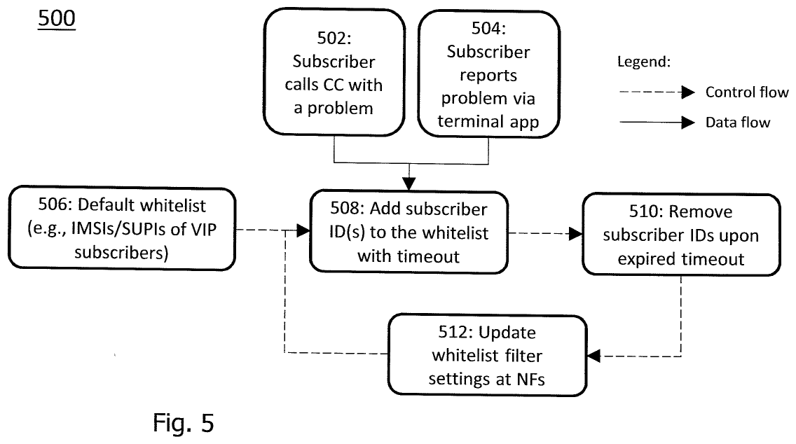

In the following, several further exemplary UCs will be discussed with reference to the diagrams of FIGS. 5 to 9.

FIG. 5 illustrates a UC 500 with the title “VIP Customer Care Monitoring”. Monitoring VIP subscribers is a frequent requirement. In order to support this requirement, IMSI or SUPI whitelist filtering is needed in NFs 140. If an NF 140 does not support such a filter setting, event reporting should be activated for all subscribers.

Customer Care (CC) UCs in general require monitoring event for all subscribers because any subscribers can call a CC agent and can complain about service quality, for example (see steps 502 and 504 in FIG. 5). The CC agent should be able to see service quality of the previous calls/sessions of the given subscriber in the CC display application. However, operators may use consent-based CC, and only those subscribers are monitored who gave their consent in advance to monitoring and storing their data. Consent can be given through a contract, an offline application, over the telephone (step 502) or via a terminal problem reporting application (step 504). In this case these subscribers are added to the IMSI or SUPI default white list filtering in the NFs 140 by the event reporting controller 136 (see steps 506 and 508).

In this UC, event reporting controller 136 receives the IMSI white list dynamically as requirement from the analytics component 134. Since the requirement for this UC is support of IMSI filtering, it is checked by the event reporting controller 136 if a given NF 140 supports IMSI white list filtering and its associated limit (e.g., of the number or the supported IMSIs, or size of the white list). Also, the capacity for adding additional IMSIs to the IMSI white list at the NFs 140 is checked. Some NFs 140 may not support IMSI filtering or use IMSI as whitelist identifier. In this case, the event reporting controller 136 requests the particular analytics component 134 that signaled the UC to provide a mapping to a supported identifier (e.g., IMSI to user equipment, UE, Internet protocol, IP, address, or IMSI to used access point name, APN, or network slice). The required white list is continually updated with the IMSIs (or other identifiers) of the VIP CC subscribers. No KPI precision information is sent in this UC, but it may indicate subscribers which cannot be monitored for some reason (e.g. not enough monitoring capacity at an NF 140). The refreshed white list is sent and updated at the NFs 140, and after that the NFs 140 produce and report events for the updated list of subscribers (steps 510, 512).

In regard to steps 510 and 512, timeout values may be used as system configuration parameters for updating or modifying the whitelist. As an example, dedicated (e.g., VIP) subscribers need not be removed from the whitelist, therefore a timeout value for their SUPIs can be set to infinity (or no timeout is applied). SUPIs of other subscribers that are added to the whitelist due to some detected or signalled problem get a suitable timeout value (e.g., 7 days) during which their SUPIs remain on the list (and get removed when the timeout expires). The timeout value may be selected such that the root cause of a network issue can likely be determined using the event data collected during that time period in the NM domain 130. Using the timeout feature helps to keep the whitelist at a manageable size.

By filtering the events right in the NFs 140 instead of doing it in the analytics components 134 after collecting them for all subscribers saves considerable hardware resources, because data collection (e.g., probing) usually consumes 30-50% of the resources of the analytics components 134. The event reporting controller 136 has access to analytics information such as correlated event records (e.g., via the analytics components 134) and it therefore can instruct NFs 140 of different domains 110, 120 to monitor the same user sessions, even if these are identified by different IDs in the different domains. The solution is integrated into the event reporting control layer and automates otherwise manual processes of merging requirements, administering timeouts, translating the desired whitelist for different types of NFs 140, and so on.

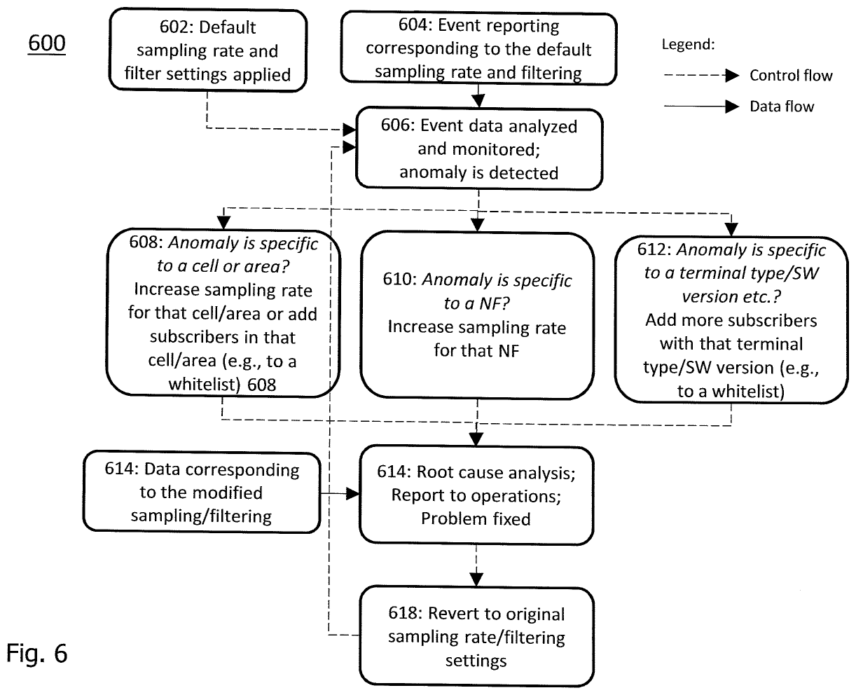

FIG. 6 illustrates a further UC 600 for activating more events to be reported in case of network anomalies. The analytics components 134 can report specific alarms, incidents or other failure cases as network anomalies (i.e., analytics information) to the event reporting controller 136 and request more events (i.e., data) related to these network anomalies in order to identify the root cause, identify further similar issues, and so on. For example, in case of a service quality incident, due to radio issues, radio events of all sessions may need to be collected in the same cell and events for these sessions may be activated in another domain by IMSI or SUPI whitelist filtering.

As another example, an incompatibility issue or high failure ratio may be detected for a new terminal type or new software version of an NF 140. In order to detect all related issues, all sessions using the same terminal types are activated in the corresponding NFs 140. This requires IMSI or SUPI whitelist filtering or international mobile equipment identity (IMEI) filtering in the NFs 140, if supported.

In FIG. 6, default reporting settings are applied by the NFs 140 and corresponding event data is constantly reported (steps 602 and 604). An analytics component 134 continuously runs anomaly detection algorithms and, upon detection of a network anomaly in step 606, indicates to the event reporting controller 136 the dimensions (NF(s) 140, terminal type)s), subscription type(s), cell(s), etc.) for which it requires more event data for root cause analysis, see steps 608, 610, 612. To this end, the event types and filtering/sampling capabilities of the NFs 140 are obtained in relation to the indicated dimensions by the event reporting controller 136. Then, it is checked if there is capacity at the NFs 140 for the requested increased event load if needed. Anomalies can be detected in analytics data already from “low percentage” sampling, but proper root cause analysis needs more reliable input data. The event reporting controller 136 may need additional info from the analytics components 134 depending on the type of anomaly (e.g., list of subscribers affected by the same issue, list of affected NFs 140, etc.) so as to trigger the reporting of more event data.

The number of events required for root cause analysis from the same cell/device type/NF 140 etc. are determined (e.g., by the analytics components 134 or the event reporting controller 136). In case of an NF issue, the simplest method is that reporting of all events is activated at the affected NFs 140. If there is not enough monitoring/reporting capacity, the sampling rate for a target precision is determined (see next section). In case of a subscriber or terminal issue, the affected subscribers are added to the white list of the affected NFs 140. The increased precision of the requested KPIs can indicated to the analytics components (see step 6 in FIG. 4). The increased event sampling rate or updated white list are configured in the corresponding NFs 140 (see again steps 608, 610, 612). Then, event data is reported for the modified settings (step 614) and used for root cause analysis (step 616). Once the problem has been fixed, one may revert to the default settings (step 618).

For example, during normal operation (there is no particular issue) the analytics components 134 require 10% random sampling at each NF 140. This is a relatively low load in terms of monitoring, reporting and processing/analysis compared to 100%. In case an anomaly is detected, e.g., related to a particular network node, terminal type, or other network dimension, more events are needed that are related to the issue in order to identify the affected subscribers s and investigate the root cause. Turning on 100% event collection would be too heavy; therefore, full event reporting is only activated only those entities which are related to affected subscribers. Assume that an NF 140 in the form of an IP multimedia sub-system (IMS) node has failed. In IMS, all events related to this node are activated for reporting (filtering for IMS node IP address). In the CN domain 110, the IMS node IP address is not a valid filtering type, therefore, the analytics component 134 or the event reporting controller 136 identifies which subscribers use the problematic IMS node and control filtering for the associated SUPIs or IMSIs (or other subscriber identifiers), using white list filtering. This white list is optionally merged with the white list determined in the currently running UCs, and data collection is activated for this merged list. In the CN domain, event reporting is done for 10% random sampling and the merged IMSI white list. In this manner coherent event filter settings can be achieved across the CN and RAN domains 110, 120.

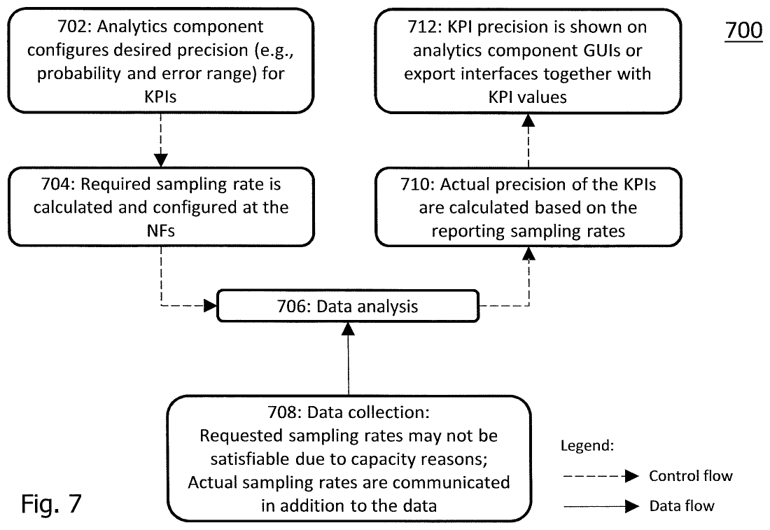

FIG. 7 illustrates a still further UC 700 for determining a required event/sampling rate in view of a requested KPI precision. KPIs are calculated from statistical samples. The accuracy of a calculated KPI mean value is determined by the statistical fluctuation of the samples. The fluctuation of data is characterized by the standard deviation of the samples. The accuracy of the KPI calculation is associated to a confidence level, which is usually selected to be 90% or 95% for network analytics applications. For each KPI, the minimum required samples for achieving a certain precision at the required confidence level can be determined as follows. The distribution of KPIs can be normal or of any other known or unknown distribution type (see, e.g., a typical distribution of the measured reference signal received power, RSRP, one of the most important radio KPIs, for a cell). When the distribution of the KPI is not normal, using the Central Limit Theorem, the mean of a nonstandard distribution is following a normal distribution, therefore for the statistics of calculating the mean selecting random samples is normal. Thus, one can apply the following formula which determines the number of samples required to obtain the mean value with a certain precision and confidence level:

N=4Z²σ²/W²,

where Z is the Z score at the desired confidence level, e.g. 95%, a is the standard deviation of the given KPI, and W is the width of the confidence interval the mean value should fell in (with 95%). Note that from this formula, the precision of the KPI W can be determined for a given number of samples and a given confidence level (e.g., if there are not enough sample and one would like to determine how it affects the KPI precision).

Referring to FIG. 7, the analytics component 134 in step 702 defines the target precision (confidence interval and confidence level) for different KPIs that are to be monitored and reported. The analytics component 134 informs the event reporting controller 136 accordingly, and the latter calculates the associated event sampling rate and configures the NFs 140 accordingly. The NFs 140 will provide corresponding event reports to the NM domain 130 for analysis (step 706).

Filtering and sampling capacities of different NFs 140 may not be sufficient to guarantee enough event data for an analysis with the required KPI prevision. In this context, the event reporting controller 136 continuously received NF reports with the current NF loads and NF capacities of the involved NFs 140. as event sources of the KPIs (step 708). The analytics component 134 may further provide information to the event reporting controller 136 on the number of active subscribers, which is the basis to determine the proper sampling rates and/or whitelists as well as to calculate the achieved precision for the already collected data. The number of required samples are determined for each NF 140. The required sampling and filtering settings are configured at the NFs 140. KPI precision at the current filter setting and/or sampling rate is calculated and reported by the event reporting controller 136 (step 710) to the analytics component 134 where this information can be displayed in addition to the KPI values (step 712). It also can be used in the presentation layer for determining the lowest resolution of the KPI presentation (e.g., 1 min, 5 min, 1 h)

In summary, KPI precision is an important extra information to be attached to the user output of the analytics systems, if any type of partial data collection (sampling and/or whitelist filtering) is used. The event reporting controller 136 may provide two services in this regard: (1) calculating the KPI precision from actual sampling/filtering settings and (2) calculating the required number of data points (to be realized by sampling and/or filtering) to reach a target precision.

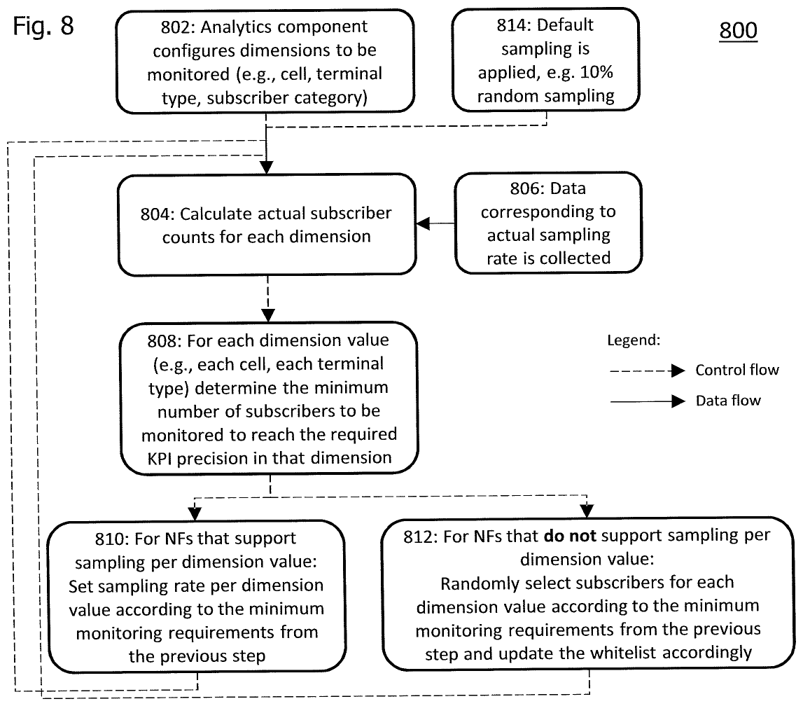

FIG. 8 illustrates a still further UC 800 for representative sampling. Many analytics use cases require KPIs for one or more dedicated dimensions, such as cell, terminal, node instance. For example, service quality per cell is an important indicator to identify underperforming cells. Radio KPIs for the same cell is important information for identifying the root cause of the service quality issues.

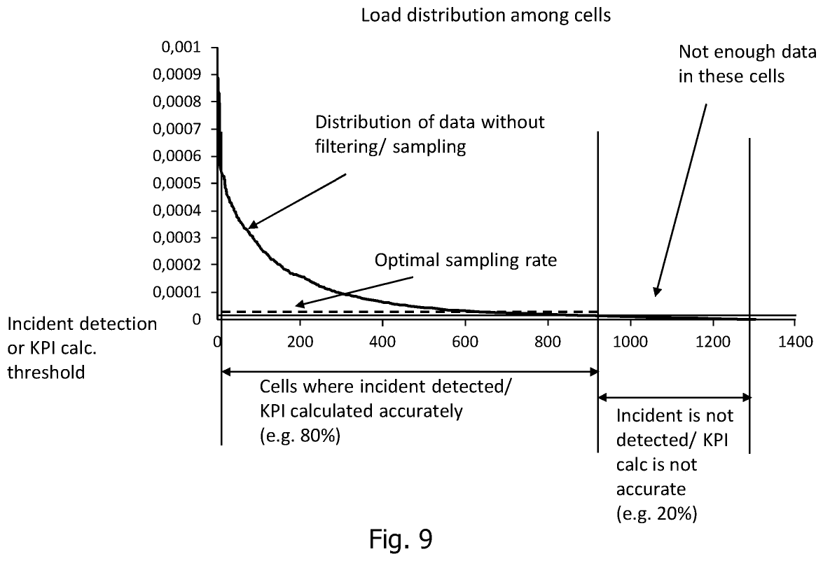

In this regard, load distribution among cells is very uneven, as it can be seen in FIG. 9. A required KPI accuracy or incident detection necessitates a certain amount of event data per cell. This amount of data is available in 80% of cells in the above example. The rest of the cells does not have enough data, so here the KPI cannot be calculated accurately, or more aggregation time is needed until the required number of samples are available. In the rest of the cells, however there are much more data than needed. The optimum sampling rate would be the one indicated by the dashed line in FIG. 9. For radio data this random sampling rate can be applied by radio base station (RBS) NFs 140, which significantly reduces the event rate from these cells in case of, e.g., a radio optimization UC.

In the user plane NFs 140 in the CN domain 110, however, there is no information on which data flow belongs to which cell. Therefore, random sampling cannot be applied. In this case, the event reporting controller 136 requests the required number of the active subscriber (e.g., IMSIs or SUPIs) per cell from the analytics component 134 and configures the corresponding number white IMSI or SUPI list or otherwise at the user plane (UP) NFs 140 in the CN domain 110. In this way, the required number of samples is obtained for UP traffic as well as per cell, and the data collection of UP is balanced per cell. Radio event data can be obtained for the same IMSI or SUPI list as well at the radio cell ensuring that the radio data are available for the same session as UP in the correlated event data records in the NM domain 130. In this regard, it is proposed to use representative sampling as follows: collect a higher fraction of data points from small subscriber groups and lower fraction from large groups. The groups can be formed via any dimension of interest, such as location, terminal type, or user category.

With respect to FIG. 8, the analytics component 134 defines target precision of different KPIs for different dimensions. Input is needed to find viable filtering/sampling settings. Load and/or capacity information from NFs 140 is needed to identify if there is any limit for data collection at the network side. Also required is information on the number of active subscribers in different dimensions (location, NF, terminal type etc.).

In step 802, the analytics component 134 determines the event dimensions to be configured as requirements vis-à-vis the event reporting controller 136, optionally together with the associated KPI precision requirements. Also, the actual counts per dimension are calculated based on the event data collected at the actual (i.e., current) sampling rate, see steps 804 and 806, by either the analytics component 134 or the event reporting controller 136. The event reporting controller 136, in step 808, then determines the minimum number of subscriber to be monitored for achieving the required KPI precision per dimension and generates associated event reporting requests for the NFs 140 as needed. The objective of determining a proper event sampling rate at the NFs 140 in the RAN domain 120 is to collect enough and about the same amount of events for each cell. KPI precision values are reported per cell to the analytics component 134 by the event reporting controller 136. The sampling/filtering rate is/are adjusted (increased/decreased) at the RAN NF(s) 140. Based on the correlation of information obtained in the NM domain 130, the user and control plane events are obtained for the same subscribers for the RAN NFs 140 as for the CN NFs 140. Depending on the available event reporting capabilities at the different NFs 140 (see steps 810, 812), representative sampling can be reached with the proper combination of sampling and filtering, especially in a cross-domain analytics scenario. In this manner coherent event filter settings can be achieved across the NFs 140.

In one example, sufficient samples for the UP KPIs and related KPIs in the RAN domain 120 are needed to check if a service quality issue is due to radio problems or not. So UP and RAN KPIs are needed for the same sessions. It is assume here that both CN domain NFs 140 and RAN domain NFs 140 support random sampling. In certain cells the data volume is much more than needed for the required KPI precision, therefore, in these cells one could apply 10% random sampling for the RAN domain 120. But in the CN domain 110 the UP report for the same sessions is needed. So the event reporting controller 136 identifies who are the subscribers for which RAN events are collected and adds these subscribers to the white list of the CN NFs 140. In this way, one collects events at a rate of 10% in the CN domain 110 as well.

A default sampling rate may initially be set for event collection (e.g., as a kind of bootstrapping/self-starting mechanism), see step 814. Note that step 804 already needs the number of actually collected event records broken down by dimension values and the applied sampling rate. From these pieces of information, it is possible to estimate the true number of subscribers broken down by dimension values. This is then used in step 808.

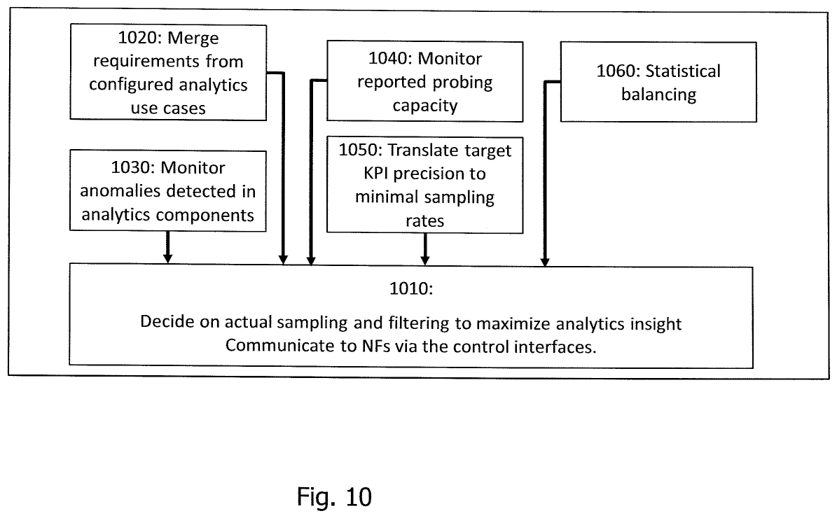

FIG. 10 summarizes the operations of the event reporting controller 136 as discussed above with reference to various examples. As a core task, the event reporting controller decides on current NF event reporting settings, such as actual sampling and filtering settings, and communicates those settings to the NFs 140 via dedicated control interfaces (see block 1010). To this end, the controller 136 merges requirements of different UCs as needed (block 1020), and continuously monitors network anomalies reported by the analytics components 134 (block 1030) and monitoring capacities reported by the NFs 140 (block 1040). The controller 136 is als capable of translating target KPI precision requirements into sampling rates (block 1050), and of performing statistical balancing, for example between different network domains, (block 1060)

Adding an extra event reporting control layer between the analytics components 134 on the one hand and the CN and RAN domains 110, 120 on the other offers significant advantages. For example, the burden of integrating sampling and filtering control of multiple NF types form multiple vendors is removed, or decoupled, from development and maintenance of the analytics components 134.

Moreover, in the embodiments described above, the event monitoring and reporting “footprint” of the NM domain 130 in the CN domain 110 and RAN domain 120 can be reduced and controlled, which is desirable in particular with the advent of 5G networks and the expected increase of devices, cells and service types. At the same time, the value and flexibility of a legacy-type “full” monitoring and reporting can be maintained.

The event reporting control layer can specifically be implemented using, for example, dynamic event filter settings and dynamic event sampling rates. If, for example, event monitoring and reporting is only required for a particular subscriber set or a particular type of user terminal, this requirement can easily be implemented while keeping the event load low on the side of the NW domain 130. At the same time, KPI precision (i.e., analysis accuracy) can be controlled as needed. Moreover, prevailing loads and capacities in the CN domain 110 and RAN domain 120 can be taken into account when it comes to event monitoring and reporting. As such, monitoring and reporting can flexibly be distributed among NFs 140 and domains 110, 120. For example, cross-domain load balancing becomes possible. The user plane probing load can be reduced in a consistent way while making sure that communication sessions specifically required for particular analytics UCs are still encompassed.

1.-33. (canceled)

34. A method for controlling reporting of network events by at least one network function (NF) of a wireless communication network, the method comprising
receiving, from at least one network analytics component of the wireless communication network, a network analytics request indicative of at least one event reporting requirement of the at least one network analytics component;
receiving multiple NF reports indicative of at least one of an event reporting capability, a load, and a capacity for the at least one NF, wherein;
first and second NF reports are received from each particular NF of the at least one NF, and
the first NF report is indicative of the event reporting capability for the particular NF, and
the second NF report is indicative of at least one of the load and the capacity for the particular NF;
generating at least one event reporting request based on the at least one event reporting requirement and at least one of the event reporting capability, the load, and the capacity for the at least one NF; and
sending the at least one event reporting request to the at least one NF so as to control event reporting by that at least one NF.

35. The method of claim 34, comprising
receiving multiple network analytics requests that are collectively indicative of multiple event reporting requirements; and
merging the multiple event reporting requirements into an overall event reporting requirement for the at least one NF, wherein the at least one event reporting request sent to the at least one NF is based on the overall event reporting requirement.

36. The method of claim 35, wherein one or more of the following applies:
at least two of the multiple event reporting requirements are received from different network analytics components; and
merging the multiple event reporting requirements comprises deriving, from respective numerical values included in at least two of the multiple event reporting requirements, an overall numerical value included in the overall reporting requirement.

37. The method of claim 34, wherein:
the NF reports are received from multiple NFs; and
the event reporting request for each particular one of the multiple NFs is individualized based on at least one of the event reporting capability, the load and the capacity for that particular NF.

38. The method of claim 34, wherein:
the event reporting requirement is indicative of at least one KPI and an associated precision requirement; and
the method further comprises calculating the event sampling rate based on the precision requirement, wherein the at least one event reporting request is indicative of at least the calculated event sampling rate and the at least one KPI.

39. The method of claim 34, wherein:
the at least one event reporting request is indicative of at least the event sampling rate; and
the method further comprises sending, to the at least one network analytics component, a message indicative of the event sampling rate or a parameter derived therefrom.

40. The method of claim 34, wherein the event filter setting is indicative of one or more of the following:
a set of one or more network subscribers to be covered by NF event reporting;
a wireless device class or type to be covered by NF event reporting; and
a geographic area to be covered by NF event reporting.

41. The method of claim 34, wherein
the NF report from the at least one NF is indicative of an NF event reporting capability in terms of an event filter supported by the at least one NF; and
generating the at least one event reporting request for the at least one NF comprises processing the network reporting requirement to result in an event filter setting compatible with the event filter supported by the at least one NF.

42. The method of claim 41, wherein:
at least two of the multiple NF reports are received from different NFs, wherein the at least two NF reports are indicative of different event filters supported by the different NFs; and
generating the at least one event reporting request comprises processing the network reporting requirements to produce coherent event filter settings compatible with the different events filters supported by the different NFs, such that the different NFs are configured to report events pertaining to a particular communication session despite their different event filters.

43. The method of claim 34, further comprising sending an NF capability request to the particular NF in response to receiving the network analytics request, wherein the first NF report is received in response to the NF capability request.

44. The method of claim 34, wherein one or more of the following applies:
the second NF report is received repeatedly after the event reporting request has been sent to the particular NF; and
the second NF report is further indicative of current event reporting settings of the particular NF.

45. The method of claim 34, further comprising:
receiving, from the at least one network analytics component, analytics information derived from the NF event reporting;
generating a further event reporting request based on at least the analytics information; and
sending the further event reporting request to the at least one NF so as to modify event reporting by that at least one NF.

46. The method of claim 45, wherein the analytics information is indicative of at least one of the following:
a network anomaly;
a number of events reported by a particular NF, optionally for a particular key performance indicator, KPI; and
a mapping of identifiers used in different network domains.

47. The method of claim 45, wherein the further event reporting request is generated also based on at least one of the event reporting capability, the load and the capacity of the at least one NF.

48. The method of claim 45, wherein:
the at least one event reporting request is indicative of at least one of the following:
an event sampling rate to be applied by the at least one NF;
an event filter setting to be applied by the at least one NF; and
one or more key performance indicators, KPIs, for which event reporting is to be performed by the at least one NF.
the further event reporting request controls a modification of at least one of the following:
an event sampling rate indicated by the at least one event reporting request;
one or more KPIs indicated by the at least one event reporting request;
a currently reporting set of NFs; and
an event filter setting indicated by the at least one event reporting request.

49. The method of claim 34, wherein:
the at least one NF is implemented using cloud computing resources; and
an amount of cloud computing resources allocated to each particular one of the NFs is dependent on the event reporting request sent to the particular NF.

50. The method of claim 34, comprising
determining if the network analytics request from the at least one network analytics component can be fulfilled in view of at least one of the event reporting capability, the load and the capacity of the at least one NF; and
sending, to the at least network analytics component, a network analytics response message indicative of a result of the determination.

51. The method of claim 34, wherein:
the method is performed by an event reporting control component having a first interface towards the at least one network analytics component and a second interface towards the at least one NF; and
the event reporting control component is co-located with the at least one network analytics component in a network management domain.

52. The method of claim 34, wherein:
a first NF of the at least one NF is part of a radio access network domain of the wireless communication network;
a second NF of the at least one NF is part of a core network domain of the wireless communication network; and
first and second NF reports are received from, and at least one event reporting request is sent to, each of the first and second NFs.

53. An apparatus arranged to controlling reporting of network events by at least one network function (NF) of a wireless communication network, the apparatus comprising:
a processor; and
a memory operably coupled to the processor and containing instructions executable by the processor, whereby execution of the instructions configures the apparatus to:
receive, from at least one network analytics component of the wireless communication network, a network analytics request indicative of at least one event reporting requirement of the at least one network analytics component;
receive multiple NF reports indicative of at least one of an event reporting capability, a load, and a capacity for the at least one NF, wherein;
first and second NF reports are received from each particular NF of the at least one NF, and
the first NF report is indicative of the event reporting capability for the particular NF, and
the second NF report is indicative of at least one of the load and the capacity for the particular NF;
generate at least one event reporting request based on the at least one event reporting requirement and at least one of the event reporting capability, the load, and the capacity for the at least one NF; and
send the at least one event reporting request to the at least one NF so as to control event reporting by that at least one NF.

54. A network management system comprising:
the apparatus of claim 62;
the at least one network analytics component; and
an event collection component, wherein:
the apparatus includes a first interface towards the at least one network analytics component and a second interface towards the at least one NF, and
the event collection component includes a third interface towards the at least one network analytics component and a fourth interface towards the at least one NF for receiving event reports from the at least one NF.
